(19) United States
(12) Patent Application Publication
(10) Pub. No.: US 2011/0010268 A1
(43) Pub. Date: Jan. 13, 2011

(54) DIGITAL CONTENT MANAGEMENT AND USAGE SYSTEM, A DIGITAL CONTENT SUPPLYING STATION, AND A METHOD OF SUPPLYING DIGITAL CONTENT

(76) Inventors: Bruno de Marchi Filho, Barra Bonita (BR); Armando Perico Neto, Lugano (CH); Marcos Macedo Maynard Araujo, Sao Paulo (BR)

Correspondence Address: NUTTER MCCLENNEN & FISH LLP, SEAPORT WEST, 155 SEAPORT BOULEVARD, BOSTON, MA, 02210-2604, US

(21) Appl. No.: 12/466,833

(22) Filed: May 15, 2009

(51) Int. Cl. G06Q 10/00; G06Q 30/00; G06F 3/041

(52) U.S. Cl. 705/26.41; 345/173

(57) ABSTRACT

The present invention discloses a digital content management and usage system, and a digital content supplying station, and more particularly the invention is related to a system that makes it possible to manage all the activities related to digital content supplying stations, that in turn makes it possible for the users to use digital content in a number of types and formats, such as music, video, cellular telephone tones, pod casts, e-books, audio-books, games, applications and any other available digital content, thus serving as a digital supplying station.

### FIELD OF THE INVENTION

The present invention discloses a digital content management and usage system, a digital content supplying station, and a method of supplying digital content, and more particularly the invention is related to a system that makes it possible to manage activities related to digital content supplying stations, that in turn makes it possible for users to use digital content in a number of types and formats, such as music, video, cellular telephone tones, podcasts, e-books, audio-books, games, applications and any other available digital content, thus serving as a digital content supplying station.

### STATE OF THE ART

Presently, there exists no self-service machine (station), or any apparatus that allows users to acquire any arbitrary type of digital content as a part of a purchase or credited redemption. Typically, digital content acquisition is made only through internet models, or web-sites (virtual stores) that sell digital content or peer-to-peer (P2P) tools that illegally share files.

Thus, anyone who owns any type of digital content device such as a media content player, cellular telephone, palm-top, among others, but does not own a personal computer or subscribe to an internet connection service is prevented from browsing and buying digital content to be used in such devices through existing web-sites and web tools.

Another problem exists-even for people who own a digital content device, a personal computer, and subscribe to an internet connection service, is that the legal channels for buying digital content over the internet make use of interfaces that are difficult to handle and browse. Typically, the user is required to register, thus supplying personal information so that a payment can be made, causing a great discomfort to the user because many of these websites do not provide adequate data security and privacy. Such payment requires, most of the time, a credit card, thus excluding more digital content consumers from the legal sales platforms. Finally, such users can easily acquire free digital content through illegal digital content-sharing sites (P2P, BitTorrent) on the same platform (PC+connection).

Thus, anyone who acquires digital content is limited to the location where his/her computer and internet connection are—generally his/her home—in order to acquire such content, which results in a great inconvenience.

The result of all such factors is that the sales of products in the entertainment industry, specially the music industry, are in a freefall. Further, the entertainment industry faces the barrier of selling such products in digital formats to a great number of people who have a lower purchasing power and can afford to buy a media content player but not a personal computer, or the monthly payment of an internet connection subscription.

On the other hand, there is a consistent increase in the number of people who migrate to the use of digital content through some sort of digital device.

With the migration of this great number of potential consumers to the legal market of digital content acquisition the entertainment industry or sector might be reinforced, thus causing an increase in legal revenue to support the emergence and creation of new artists and contents, respectively.

Thus, besides addressing the above mentioned inconveniences, it is desirable that both the digital content management and usage system and the digital content supplying system allow the migration of this great number of potential consumers to the legal market of digital content acquisition to reinforce the sector, causing an increase in legal revenue to support the emergence of new artists and creation of new contents.

### BRIEF DESCRIPTION OF THE INVENTION

According to an embodiment of the present invention, the digital content management and usage system and the digital content supplying station comprises a data center where central servers designed to store data and digital content, credit management as well as data and digital content management are located, and connected to a network of digital content supplying stations where each station is provided with a database and a content base, to a central office to manage all transactions, to content supplying companies, and to central security servers. The digital content supplying station comprises a enclosure that can be attached to the wall or a support, a Central Processing Unit (CPU), a display, connectors for to transfer files to devices, and a power source.

The present invention is better understood with the detailed description of a preferred but non-limitative embodiment of the system, the station, and the digital content supplying method that are represented by the attached figures in an exemplary way.

### DESCRIPTION OF THE FIGURES

FIG. 1—A diagram of a digital content management and usage system.

FIG. 2—An multi-layered perspective view of a digital content supplying station.

FIG. 3—A side view of the digital content supplying station.

FIG. 4—A front view of the digital content supplying station.

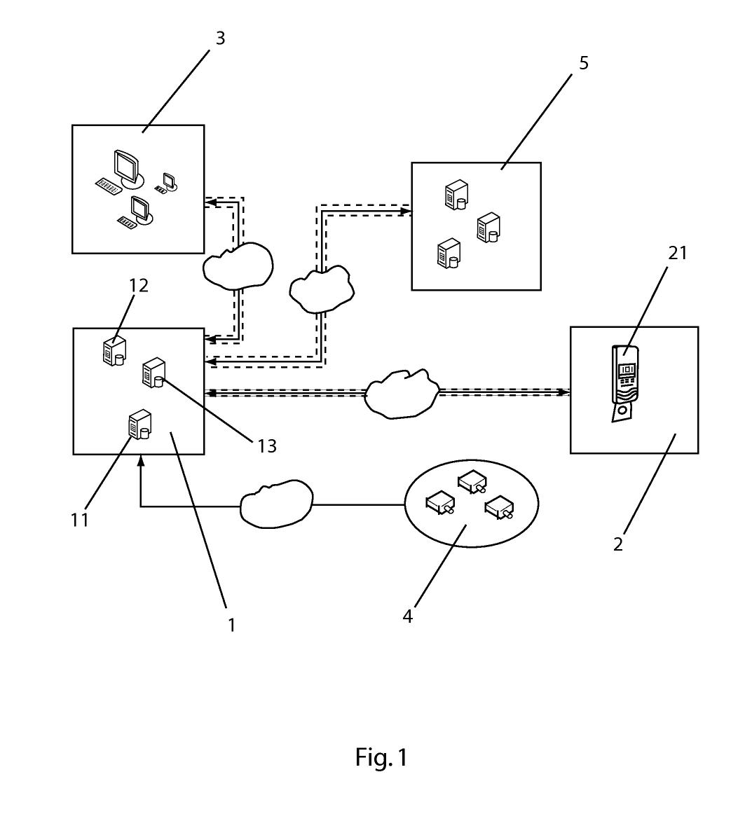

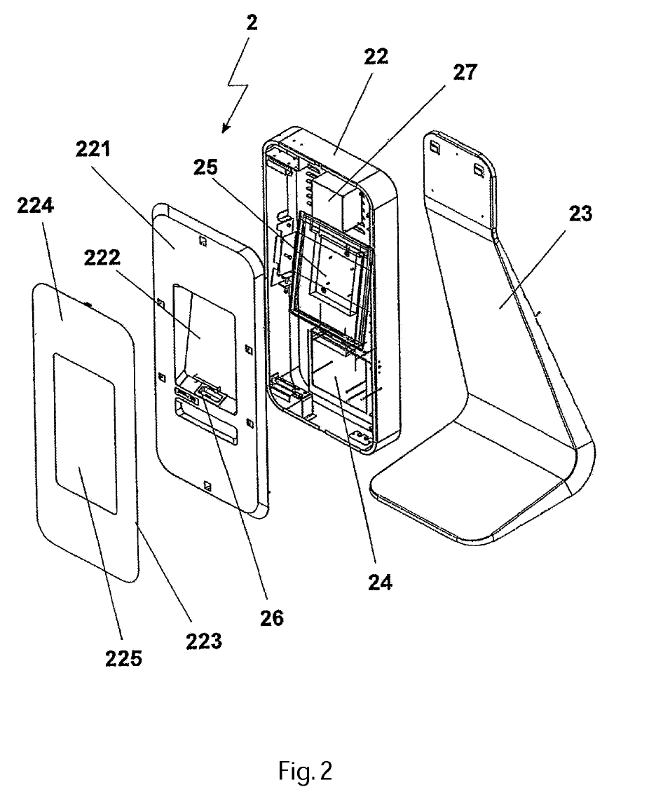

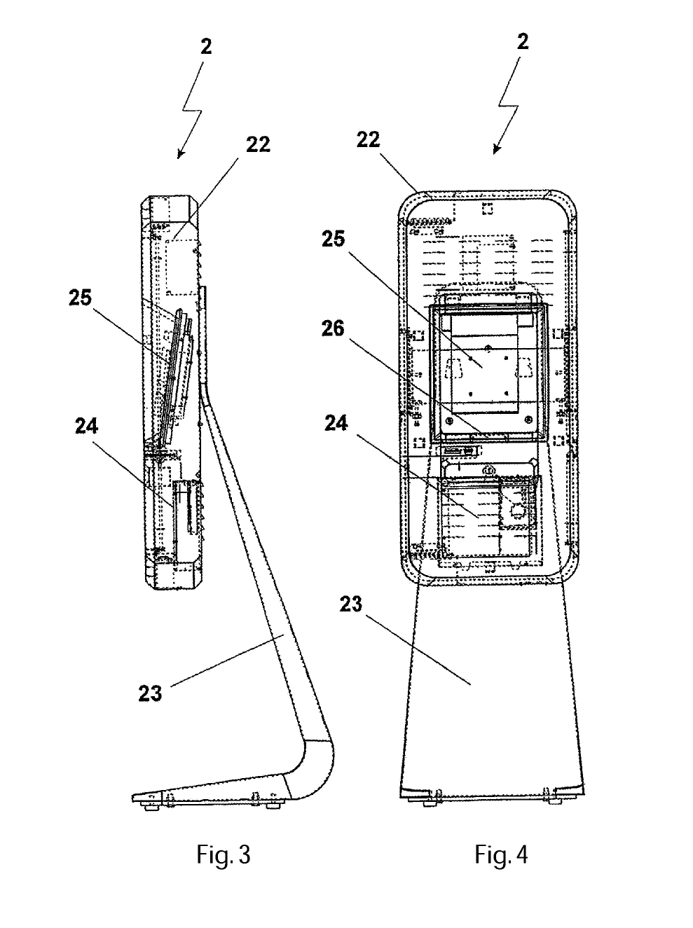

### DETAILED DESCRIPTION OF A PREFERRED EMBODIMENT

According to the figures, the digital content management and usage system comprises a platform that includes a datacenter (1) where central servers designed to store data and digital content (11), to perform credit management (12) and to perform data and digital content management (13) are located, and connects to a network of digital content supplying stations (2) where each digital content supplying station (21) is provided with a database and a content base, to a central office (3) to manage all the transactions, to the digital content supplying companies (4), and to the central backup servers (5).

The digital content supplying station (21) comprises a substantially rectangular enclosure (22) provided with rounded corners, having a closed back and a front provided with a cover (221) having an opening with an undercut (222), and an upper cover (223) provided with room for advertising (224) and an opening (225), which can be attached to the wall or a support (23). The enclosure (22) is provided internally with a Central Processing Unit (CPU) (24), a LCD monitor display (25) having a “touch screen” USB type connectors for file transfer devices (26), a card reader, iPod docking port, Bluetooth transceiver, and a power source (27). The CPU is placed entirely inside a sealed metal box, with a plug-in connector on the station, in case it needs to be replaced or repaired quickly. The connectors for the devices are located on the front and connects to the CPU through a cable connecting system in a main harness, and the “touch screen” monitor display is installed in the enclosure through a mechanism to set height and depth.

The system allows the user to acquire digital content in a number of types and formats, such as music, video, cellular telephone tones, podcasts, e-books, audio-books, games and applications through the stations, since the entire content is stored in a HD (hard disc) connected to the CPU inside the station.

All the digital content supplying stations are connected to one another and with the datacenter servers to form a data and information traffic network that performs operations such as validation of payments, transfer of contents, system and catalog updates, monitoring of services and operations, monitoring of the integrity and operation of the station, and “on-line” assistance.

The digital contents that are made available through the system is stored in the central content server. The stations have a content base displayed to the user by the graphical interface of each station, so that a file transfer traffic is not always necessary between station and server. However, in the event that a search for a content that is not available in the station, each station connects with the other stations and the central server to check the availability of the searched content.

The operations of supplying the content carried out at each of the stations may be validated by typing a code of personal identification number code (PIN code) that is acquired in the form of a pre-paid card or any other means. Such code is typed by the user using the interface during the acquisition process of digital content. All operations performed at each of the stations are stored and sent to the central servers to generate periodical reports, so that user accounts can be settled and the payments can be made to the respective licensers (publishers, recording companies, artists) of the distributed/sold content.

The PIN code used for the validation of the purchase may be the security code for both the user and the platform. From the time the user types the PIN code, the system stores the information related to the transaction made with said code.

In a preferred embodiment, the PIN code is provided by a card, similar to those used by the telephone company for selling pre-paid credit, as a “carrier”. There will be a message on such cards informing the user that the PIN code printed in the card is his/her guarantee, and said card should be kept safe until the receipt and integrity of the files bought with it are confirmed.

The system validates the purchase by checking the PIN code in the server. The content is transferred only after a PIN code that corresponds to the monetary amount of the product to be transferred is validated.

Once the PIN code is validated, the operation is registered and all the data associated with the PIN code are stored (date, time, station ID, content to be transferred, value of the transaction, etc). Only then a transfer of contents to the device of the user is initiated.

For the supply of contents, the recording companies may send to the Management Center content and data in various standards or formats, and the publishers may send the respective content release. The Management Center optionally standardizes the content and data received according to a single standard used by the system, and those contents or data already standardized are sent to the central server that redirects them to all the stations according to user demand.

The sales are registered and sent to the central server, which sends the data to the Management Center. The sales data are organized and customized according to the respective owners of the sold content and are sent to the owners from time to time, in addition to being available to be tracked “on-line” on the internet.

Recording companies or publishers are logged in the data center through their unique user names and passwords so that as content suppliers they may monitor distribution of their digital contents. The data center stores all data related to sales carried out by the stations until that time, and such sales data are organized according to the respective content supplier or licenser. Thus, the recording companies or publishers may access and receive the data related to the sales of their respective products.

With the digital content management and usage system and the digital content supplying station thus provided, obtaining digital content is very simple—the user browses through the graphical interface in a “touch screen” monitor display, chooses the desired contents, and sends them to a purchase cart. Subsequently, the user selects one of the following methods to transfer the content to his/her device: Bluetooth connection, USB connection, iPod docking, or via Memory Card, and connects his/her device to the station and makes payment by typing a PIN code. Once the payment is completed, the system validates the PIN and the respective credit related to the purchase. When a credit of the PIN code typed by the server is validated, the transfer of the content to the device of the user is initiated. After the content is transferred, a file is generated containing the data of the transaction that contains information such as, for example, the name of the media, the station where the transaction was carried out, date and time, etc, and this file is sent to the central server, thus storing all the data relevant to said transaction, for later settlements with the related right owners (licensers, point of sales, authors, etc).

With the digital content management and usage system and the digital content supplying station, the receipt of digital content in a fast, secure, and legal way is provided, without requiring the user to have either a computer with an internet connection, or cables and connectors, except the devices for holding the transferred content.

The scope of the present invention should not, therefore, be limited to the disclosed applications, but only to the terms defined in the claims and the equivalents thereof.

What is claimed is:

1. A digital content management and usage system, comprising
a datacenter where central servers designed to store data and digital content to perform credit management and to perform data and digital content management are located; which connects to
a network of digital content supplying stations where each digital content supplying station is provided with a data and content base; and connects to
a central office to manage all transactions; and connects to
content supplying companies; and connects to
central backup and security servers.

2. The system, according to claim 1, further allows a user to acquire digital content in a number of types and formats, such as music, video, cellular telephone tones, podcasts, e-books, audio-books, games and applications through the stations.

3. The system, according to claim 1, characterized in that all the stations are connected to one another and with the datacenter servers making a network of data and information traffic for operations such as validation of payments, transfer of contents, system and catalog updates, monitoring of services and operations, monitoring the integrity and operation of the station, and “on-line” assistance.

4. The system, according to claim 1 or 3, characterized in that operations of sending the content carried out by the station will be validated by typing a code of personal identification number code (PIN code).

5. The system, according to claim 4, characterized in that the PIN code is acquired in the form of a pre-paid card or any other means, typed by the user in the interface during the acquisition process of the related content.

6. A digital content supplying station, comprising a enclosure, having a closed back and a front provided with a cover (221) having an opening with an undercut (222) and an upper cover (223) provided with room for advertising (224), and an opening (225), which can be attached to the wall or a support (23), the enclosure (22) being provided internally with a Central Processing Unit (CPU) (24), a monitor display (25) having a “touch screen” technology, connectors for file transfer devices (26), and a power source (27).

7. The digital content supplying station, according to claim 6, characterized in that the “touch screen” monitor display is installed in the enclosure through a mechanism that makes it possible to set both the height and depth.

8. The digital content supplying station, according to claim 6, characterized in that the enclosure has any shape that may satisfy the needs of the station.

9. The digital content supplying station, according to claim 6, characterized in that the connectors for file transfer devices (26) are of the USB type, card reader, iPod, Bluetooth.

10. The digital content supplying station, according to claim 6, characterized in that the whole content is stored in a HD (hard disc) in the CPU inside of the station.

11. A method of supplying digital content comprising:
providing a datacenter where central servers designed to store data and digital content to perform credit management and to perform data and digital content management are located; which connects to
providing a network of digital content supplying stations where each digital content supplying station is provided with a data and content base; and connects to
providing a central office to manage all transactions; and connects to
content supplying companies; and connects to
central backup and security servers.
